(19) United States
(12) Patent Application Publication
(10) Pub. No.: US 2025/0026383 A1
(43) Pub. Date: Jan. 23, 2025

(54) MONITORING DEVICE, STORAGE MEDIUM STORING COMPUTER PROGRAM FOR MONITORING, AND MONITORING METHOD

(71) Applicants: TOYOTA JIDOSHA KABUSHIKI KAISHA, Toyota-shi (JP); AISIN CORPORATION, Kariya (JP); DENSO CORPORATION, Kariya-city (JP)

(72) Inventors: Udara Eshan Manawadu, Tokyo-to (JP); Takuhiro Omi, Anjo-shi (JP); Hiroshi Morimoto, Tokyo-to (JP); Kenta Yamada, Tokyo-to (JP)

(21) Appl. No.: 18/741,882

(22) Filed: Jun. 13, 2024

(30) Foreign Application Priority Data
Jul. 19, 2023 (JP) 2023-117688

(51) Int. Cl. B60W 60/00; B60W 50/14

(52) U.S. Cl. CPC B60W 60/0057; B60W 50/14; B60W 60/0053; B60W 2420/403; B60W 2540/223; B60W 2540/229

(57) ABSTRACT

A monitoring device has a processor configured to determine whether a degree of preparedness of a driver to initiate manual control is a first degree in which manual control of a vehicle is possible, a second degree which is allowed while the vehicle is being operated by automatic control or a third degree which is not allowed while the vehicle is being operated by automatic control, based on posture information indicating a posture of the driver, acquired while the vehicle is being operated by automatic control, and a notification control unit that provides a predetermined notification to increase the degree of preparedness of the driver to initiate manual control, via a notification unit, when it has been determined that the degree of preparedness to initiate manual control is the third degree.

### FIELD

The present disclosure relates to a monitoring device, a storage medium storing a computer program for monitoring, and a monitoring method.

### BACKGROUND

An automatic control system for a vehicle does not constantly require that the vehicle be operatable by the driver while the vehicle is being driven by automatic control. When the vehicle is being driven by automatic control, the driver may move the seat position in order to adopt a relaxed posture, for example.

However, when it has judged that the vehicle cannot be safely driven by automatic control, the automatic control system asks the driver to transfer driving of the vehicle from automatic control to manual control (takeover request=TOR).

Japanese Unexamined Patent Publication No. 2017-210013, for example, proposes a driver condition-detecting device that stores a correspondence relationship between the difference by which physical information of the driver falls outside of a standard range and the time until it returns to the standard range, and based on that correspondence relationship estimates the return time until the acquired physical information returns to the standard range, making a judgment that the driver is in a condition unable to drive the vehicle if the estimated return time exceeds a predetermined acceptable time. The standard range represents physical information associated with the driver being able to operate the vehicle.

### SUMMARY

A driver must initiate manual control of the vehicle in response to a TOR request. The automatic control system executes control transfer so as to transfer control of the vehicle to the driver at a predetermined time from the time point at which a TOR request notification was given (10 seconds, for example).

When the automatic control system has notified the driver of the TOR request, it is possible, depending on the posture of the driver, that the time required for the driver to return to a condition allowing manual control of the vehicle may exceed the time allowed for transfer.

From the viewpoint of allowing the driver to be in as relaxed a posture as possible, on the other hand, it is preferred for the allowed posture to be in a range such that the driver can return to a state allowing manual control of the vehicle within the predetermined time after the automatic control system has notified the driver of the TOR request.

A requirement for the driver to be in a posture to allow immediate operation of the vehicle even if the driver is in a posture which does not allow operation of the vehicle, as in Japanese Unexamined Patent Publication No. 2017-210013, may prevent the driver from being able to adopt a relaxed posture.

In other words, while a condition allowing driving of the vehicle by manual control cannot be required at all times during driving of the vehicle by automatic control, the driver can still be required to be prepared to initiate manual control, at least to an extent allowing manual driving of the vehicle to be initiated within a predetermined time period.

It is an object of the present disclosure to provide a monitoring device that does not notify the driver when the degree of preparedness to initiate manual control based on the posture of the driver is a degree allowing manual control of the vehicle, or is a degree allowed while the vehicle is being operated by automatic control, but that only notifies the driver to increase the degree of preparedness of the driver to initiate manual control when it is a degree not allowed while the vehicle is being operated by automatic control.
(1) According to one embodiment, the invention provides a monitoring device. The monitoring device a processor configured to determine whether a degree of preparedness of a driver to initiate manual control is a first degree in which manual control of a vehicle is possible, a second degree which is allowed while the vehicle is being operated by automatic control or a third degree which is not allowed while the vehicle is being operated by automatic control, based on posture information indicating a posture of the driver, acquired while the vehicle is being operated by automatic control, and provide a predetermined notification to increase the degree of preparedness of the driver to initiate manual control, via a notification unit, when it has been determined that the degree of preparedness to initiate manual control is the third degree.
(2) The monitoring device of embodiment (1) above, it is preferable that the processor is further configured to estimate a transfer time required for the driver to be in a state allowing initiation of operation of the vehicle in manual driving mode, after the driver has been notified via the notification unit of a transfer request for transfer from self-driving mode in which the vehicle is driven by automatic control to manual driving mode in which the vehicle is driven by manual control, based on the posture information, and determine that the degree of preparedness of the driver to initiate manual control is the first degree when the transfer time is zero, determine that the degree of preparedness of the driver to initiate manual control is the second degree when it has been determined that the transfer time does not exceed a predetermined reference time, and determine that the degree of preparedness of the driver to initiate manual control is the third degree when it has been determined that the transfer time exceeds the predetermined reference time.
(3) The monitoring device of embodiment (2) above, it is preferable that the predetermined reference time is decided based on time required for the driver to begin operation of the vehicle in manual driving mode after the driver has been notified of the control transfer request.
(4) The monitoring device of embodiment (2) above, it is preferable that the posture information includes seat position information indicating a position of the driving seat in which the driver is seated, and the processor is further configured to estimate the transfer time based on the seat position information.
(5) The monitoring device of embodiment (1) above, it is preferable that the posture information includes an image in which the driver is represented, and the processor is further configured to determine that the degree of preparedness to initiate manual control is the third degree when the driver represented in the image is in a predetermined posture.
(6) The monitoring device of embodiment (5) above, it is preferable that the predetermined posture includes an arm-folded posture and a leg-crossed posture.
(7) The monitoring device of any one of embodiments (1) to (6) above, it is preferable that the processor is further configured to determine whether or not the degree of preparedness of the driver to initiate manual control is low based on the state of awareness indicating a degree to which the driver is participating in driving, and provide the predetermined notification to the driver when it has been determined based on the posture information that the degree of preparedness of the driver to initiate manual control is the third degree, and it has been determined based on the state of awareness that the degree of preparedness of the driver to initiate manual control is low.
(8) According to another embodiment, a non-transitory storage medium storing a computer program for monitoring is provided. The computer program for monitoring causes a processor to execute a process, and the process includes determining whether a degree of preparedness of a driver to initiate manual control is a first degree in which manual control of a vehicle is possible, a second degree which is allowed while the vehicle is being operated by automatic control or a third degree which is not allowed while the vehicle is being operated by automatic control, based on posture information indicating a posture of the driver, acquired while the vehicle is being operated by automatic control, and providing a predetermined notification to increase the degree of preparedness of the driver to initiate manual control, via a notification unit, when it has been determined that the degree of preparedness to initiate manual control is the third degree.
(9) According to yet another embodiment of the invention there is provided a monitoring method. The monitoring method includes determining whether a degree of preparedness of a driver to initiate manual control is a first degree in which manual control of a vehicle is possible, a second degree which is allowed while the vehicle is being operated by automatic control or a third degree which is not allowed while the vehicle is being operated by automatic control, based on posture information indicating a posture of the driver, acquired while the vehicle is being operated by automatic control, and providing a predetermined notification to increase the degree of preparedness of the driver to initiate manual control, via a notification unit, when it has been determined that the degree of preparedness to initiate manual control is the third degree.

The monitoring device of the present disclosure does not notify the driver when the degree of preparedness to initiate manual control based on the posture of the driver is a degree allowing manual control of the vehicle, or is a degree allowed while the vehicle is being operated by automatic control, but it notifies the driver to increase the degree of preparedness of the driver to initiate manual control when it has been determined that the degree of preparedness is a degree not allowed while the vehicle is being operated by automatic control, and therefore with such a construction the driver can adopt a more relaxed state while still ensuring that the driver can return to a state allowing manual control within a predetermined time.

The object and advantages of the invention will be realized and attained by means of the elements and combinations particularly specified in the claims. It is to be understood that both the foregoing general description and the following detailed description are exemplary and explanatory and are not restrictive of the invention, as claimed.

### BRIEF DESCRIPTION OF DRAWINGS

FIG. 1A is a diagram illustrating operation of the monitoring device of the embodiment in overview, and showing a vehicle.

FIG. 1B is a diagram illustrating operation of the monitoring device of the embodiment in overview, and showing a driving seat in manual driving mode.

FIG. 1C is a diagram illustrating operation of the monitoring device of the embodiment in overview, and showing a driving seat in self-driving mode.

FIG. 2 is a hardware configuration diagram for a vehicle in which the monitoring device of the embodiment is mounted.

FIG. 3 is an example of an operation flow chart for monitoring processing by the monitoring device of the embodiment.

FIG. 4 is an example of an operation flow chart for determination processing by the monitoring device of the embodiment.

FIG. 5 is another example of an operation flow chart for determination processing by the monitoring device of the embodiment.

FIG. 6 is an example of an operation flow chart according to a modified example for monitoring processing by the monitoring device of the embodiment.

FIG. 7 is an example of an operation flow chart for estimation processing by the monitoring device of the embodiment.

### DESCRIPTION OF EMBODIMENTS

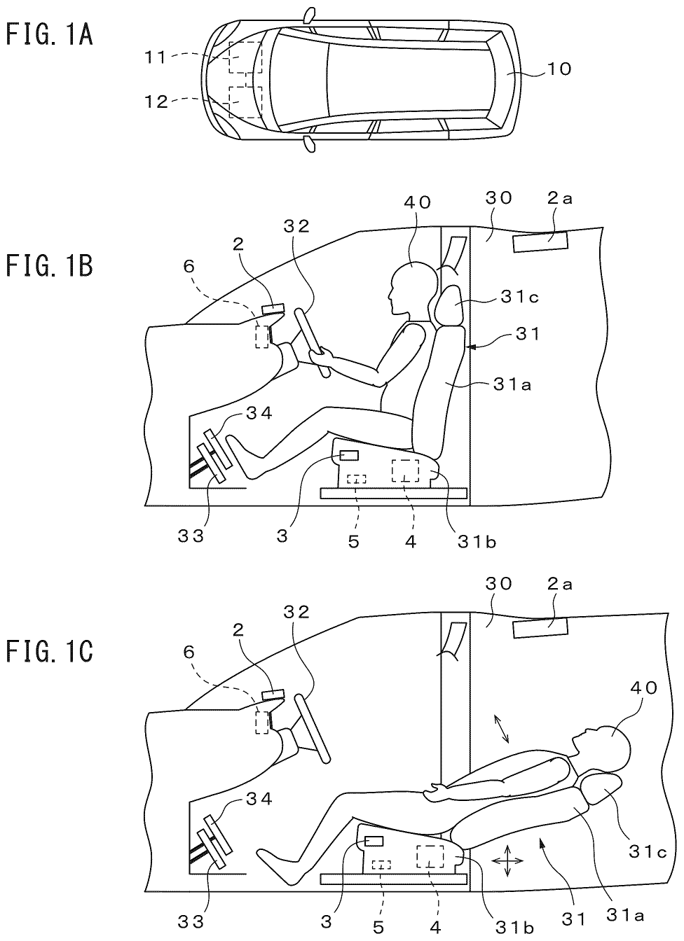

FIG. 1A to FIG. 1C are diagrams illustrating operation of a monitoring device of the embodiment in overview. FIG. 1A shows a vehicle 10, FIG. 1B shows a driving seat 31 in manual driving mode, and FIG. 1C shows the driving seat 31 in self-driving mode.

As shown in FIG. 1A, the vehicle 10 has an automatic control device 11 and monitoring device 12. The automatic control device 11 has a self-driving mode wherein the vehicle 10 is driven primarily by the automatic control device 11 (for example, driving mode with levels 3 to 5) and a manual driving mode in which the vehicle 10 is driven primarily by the driver 40 (for example, driving mode with levels 0 to 2).

In manual driving mode, the monitoring device 12 moves the position of the driving seat 31 in response to operation of a seat operating unit 3 by the driver 40. In manual driving mode, the monitoring device 12 stores the position of the driving seat 31 (hereunder also referred to as “manual driving position”) set by the driver 40.

In manual driving mode, as shown in FIG. 1B, the automatic control device 11 controls operation of the vehicle 10 based on manipulation by the driver 40. The driver 40 sits in the driving seat 31 in the cabin 30 in a manner allowing control of the steering wheel 32, brake pedal 33 and accelerator pedal 34.

In self-driving mode, it is not required for the driver 40 to be in a state allowing operation of the vehicle 10 at all times. In self-driving mode, the monitoring device 12 moves the position of the driving seat 31 in response to operation of the seat operating unit 3 by the driver 40. The monitoring device 12 stores the seat position of the driving seat 31. In self-driving mode, the driver 40 may move the position of the driving seat 31 so as to adopt a relaxed posture, as shown in FIG. 1C.

When it has been determined in self-driving mode that the vehicle 10 cannot be safely driven by automatic control, the automatic control device 11 notifies the driver 40, via the user interface (UI) 6, of a control transfer request to transfer main driving of the vehicle 10 from the automatic control device 11 to the driver 40. Once the driver 40 has been notified of the control transfer request, the automatic control device 11 carries out control transferring so that control of the vehicle 10 is transferred to the driver, at a control transfer time. The control transfer time may be 10 seconds, for example.

When the driver 40 has been notified of a control transfer request, the monitoring device 12 moves the driving seat 31 to the manual driving position. The driver 40 thus begins operation of the vehicle 10 in manual driving mode, after having carried out a predetermined operation of approving the control transfer request. The control transfer time includes a moving time during which the driving seat 31 is moved from the current seat position to the manual driving position, and an approval time required for the driver 40 to carry out the operation of approving the control transfer request.

The approval time is assumed to be essentially a fixed time period, but the moving time required for the driving seat 31 to move to the manual driving position differs depending on the position of the driving seat 31 in self-driving mode. The moving time for moving the driving seat 31 from the current seat position to the manual driving position corresponds to a preparation transition time required for the driver 40 to be in a state allowing operation of the vehicle 10 to begin in manual driving mode.

In self-driving mode, the monitoring device 12 determines whether or not the degree of preparedness of the driver 40 to initiate manual control is low, based on posture information representing the posture of the driver 40.

If the position of the driving seat 31 is further from the manual driving position, this means that the hand of the driver 40 is further from the steering wheel 32, and/or that the foot of the driver 40 is further from the brake pedal 33 and accelerator pedal 34. The degree of preparedness of the driver 40 to initiate manual control may be considered to be low in such postures. The position of the driving seat 31 is an example of posture information.

The monitoring device 12 determines the degree of preparedness of the driver 40 to initiate manual control based on the position of the driving seat 31. First, based on the position of the driving seat 31, the monitoring device 12 calculates a preparation transition time required for the driver 40 to be in a state allowing operation of the vehicle 10 to begin in manual driving mode.

Specifically, based on the preparation transition time, the monitoring device 12 determines whether the degree of preparedness of the driver 40 is a first degree in which manual control of the vehicle 10 is possible, a second degree which is allowed while the vehicle is being operated by automatic control, or a third degree which is not allowed while the vehicle is being operated by automatic control.

When the preparation transition time is zero, the monitoring device 12 determines that the degree of preparedness to initiate manual control is high. When the driving seat 31 is in the manual driving position, this is an example where the degree of preparedness of the driver 40 to initiate manual control is the first degree in which manual control of the vehicle 10 is possible.

When the preparation transition time exceeds a predetermined reference time, the monitoring device 12 determines that the degree of preparedness of the driver 40 to initiate manual control is low. When the driving seat 31 is at a location where the preparation transition time exceeds the reference time, this is an example where the degree of preparedness of the driver 40 to initiate manual control is the third degree, which is not allowed while the vehicle 10 is being operated by automatic control.

When the preparation transition time is not zero but does not exceed a predetermined reference time, the monitoring device 12 determines that the degree of preparedness of the driver 40 to initiate manual control is high. When the driving seat 31 is at a location where the preparation transition time does not exceed the reference time, this is an example where the degree of preparedness of the driver 40 to initiate manual control is the second degree, which is allowed while the vehicle 10 is being operated by automatic control. When the preparation transition time is zero, the monitoring device 12 determines that the degree of preparedness of the driver 40 to initiate manual control is high. A preparation transition time of zero means that the driving seat 31 is in the manual driving position. When the driving seat 31 is in the manual driving position, this is an example of the degree of preparedness of the driver 40 to initiate manual control being the first degree in which manual control of the vehicle 10 is possible.

When the degree of preparedness of the driver 40 to initiate manual control is low, the monitoring device 12 provides a driving preparation notification, via the UI 6, until the driver 40 adopts a posture allowed when the vehicle 10 is being driven by automatic control.

When a driving preparation notification has been given, the driver 40 operates the seat operating unit 3 to move the position of the driving seat 31 closer to the manual driving position until the driving preparation notification is no longer given.

The position of the driving seat 31 is thus set within a range such that the moving time during which the driving seat 31 will move to the manual driving position in self-driving mode does not exceed the reference time. After the driving seat 31 has moved to the manual driving position and the driver 40 has given approval within the control transfer time after the driver 40 has been notified of the control transfer request, the driver 40 may begin operation of the vehicle 10 in manual driving mode.

In self-driving mode, the position of the driving seat 31 may be set to a position so that the driver 40 can adopt a relaxed posture within a posture range allowed for the driver 40 when the vehicle 10 is being driven by automatic control.

Since, as explained above, the monitoring device 12 of the embodiment can give the driver a notification to increase the degree of preparedness of the driver 30 to initiate manual control when it has been determined that the degree of preparedness of the driver 40 to initiate manual control is low, the driver 30 is able to maintain a state that can return to a state allowing manual control within the predetermined time period.

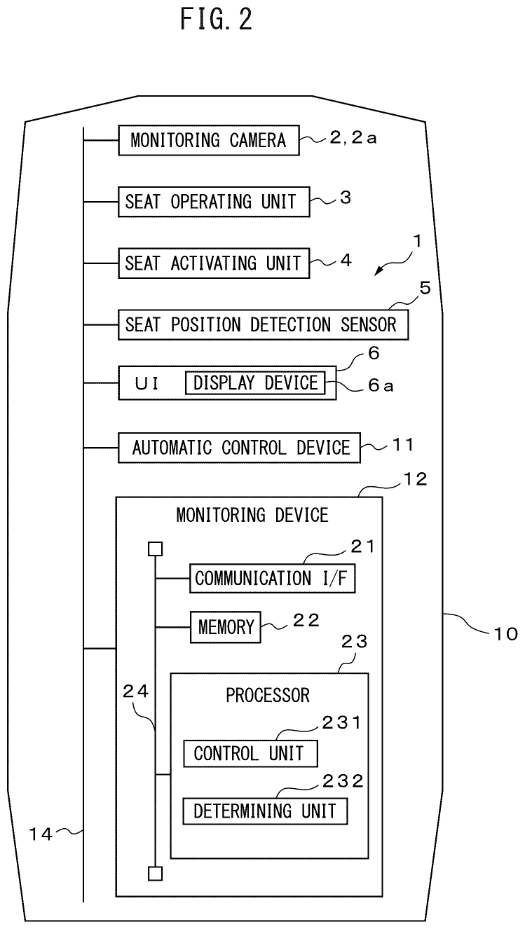

FIG. 2 is a hardware configuration diagram of a vehicle 10 in which a monitoring system 1 is mounted that includes a monitoring device 12 of the embodiment. The vehicle 10 has monitoring cameras 2, 2a, a seat operating unit 3, a seat activating unit 4, a seat position detection sensor 5, a user interface (UI) 6, an automatic control device 11 and a monitoring device 12. The monitoring system 1 includes at least the monitoring camera 2, the seat position detection sensor 5, the automatic control device 11 and the monitoring device 12.

The monitoring cameras 2, 2a, seat operating unit 3, seat activating unit 4, seat position detection sensor 5, UI 6, automatic control device 11 and monitoring device 12 are connected in a communicable manner via an in-vehicle network 14 conforming to the Controller Area Network standard.

The monitoring cameras 2, 2a are disposed in the cabin 30 in a manner allowing them to acquire monitor images including the face of the driver 40 driving the vehicle 10. The monitoring camera 2 is disposed on the dashboard, for example. The monitoring camera 2a is disposed on the ceiling behind the cabin 30, for example.

The monitoring cameras 2, 2a are examples of image acquisition units. The monitoring camera 2 acquires a monitor image representing the surroundings of the driving seat 31 at a monitor image acquisition time at a predetermined cycle. The monitoring camera 2a acquires a monitor image representing the interior of the cabin 30 at a monitor image acquisition time in synchronization with the monitoring camera 2. The monitoring camera 2a can acquire monitor images of the driving seat 31 when located at the rear.

The monitoring cameras 2, 2a each have a 2D detector composed of an array of photoelectric conversion elements with infrared sensitivity, such as a CCD or C-MOS, and an imaging optical system that forms an image of the acquired region on the 2D detector.

Each time monitor images are acquired, the monitoring cameras 2, 2a output the monitor images and the image acquisition times at which the monitor images were acquired, to the monitoring device 12 via the in-vehicle network 14. The monitor images are used by the monitoring device 12 to estimate the posture of the driver 40. The monitor images are examples of posture information.

The driving seat 31 has a seat back 31a, a seat cushion 31b and a headrest 31c. The inclination of the seat back 31a can be discretely displaced across 10 levels. The seat cushion 31b can be discretely displaced across 10 levels as positions both in the front-back direction and the up-down direction. The headrest 31c can be discretely displaced across 10 levels both as inclination and as positions in the up-down direction. For the purpose of the present specification, the position of the driving seat 31 includes the inclination and/or the position of the driver seat 31.

The seat operating unit 3 is operated by the driver 40 and outputs an operation signal to the monitoring device 12 representing the position to which the driving seat 31 is to be displaced. Based on the operation signal, the monitoring device 12 generates a driving signal to displace the position of the driving seat 31 and outputs it to the seat activating unit 4. The seat activating unit 4 displaces the driving seat 31 based on the driving signal. The seat operating unit 3 has respective switches for operation of the seat back 31a, seat cushion 31b and headrest 31c. The monitoring device 12 stores the seat position of the driving seat 31.

The seat activating unit 4 has drive units such as motors for displacement of the seat back 31a, seat cushion 31b and headrest 31c. In FIG. 1B, the seat activating unit 4 is disposed in the seat cushion 31b, but the seat activating unit 4 may instead be disposed separately in the seat back 31a, seat cushion 31b and headrest 31c. The seat activating unit 4 is controlled by the monitoring device 12 to vibrate the seat back 31a, seat cushion 31b and headrest 31c.

The seat position detection sensor 5 detects the inclination or position of each part of the driving seat 31. The seat position detection sensor 5 detects the inclination of the seat back 31a and outputs seat position information representing the inclination of the seat back 31a to the monitoring device 12. The seat position detection sensor 5 also detects the positions of the seat cushion 31b in the front-back direction and the up-down direction, and outputs seat position information representing the positions of the seat cushion 31b in the front-back direction and the up-down direction to the monitoring device 12. The seat position detection sensor 5 further detects the inclination and position in the up-down direction of the headrest 31c, and outputs inclination information representing the inclination and seat position information representing the position in the up-down direction of the headrest 31c, to the monitoring device 12. The seat position information is an example of posture information.

The seat position detection sensor 5 may have sensors for mechanical, optical or magnetic detection of the positions of the seat back 31a, seat cushion 31b and headrest 31c. In FIG. 1B, the seat position detection sensor 5 is disposed in the seat cushion 31b, but the seat position detection sensor 5 may instead be disposed separately in each of the seat cushion 31b and headrest 31c.

The UI 6 is an example of the notification unit. The UI 6, controlled by the automatic control device 11 or monitoring device 12, notifies the driver 40 of information relating to the vehicle 10, such as control transfer requests. The UI 6 has a display device 6a such as a liquid crystal display or touch panel, for display of information such as control transfer requests. The UI 6 may also have an acoustic output device (not shown) to notify the driver 40 of control transfer requests. The UI 6 also has a touch panel or operating button, for example, as an input device for inputting operation information from the driver 40 to the vehicle 10. The UI 6 outputs the input operation information to the automatic control device 11 via the in-vehicle network 14.

The automatic control device 11 controls operation of the vehicle 10. The automatic control device 11 has a self-driving mode in which the vehicle 10 is driven by automatic control, and a manual driving mode in which operation of the vehicle 10 is controlled based on manipulation by the driver 40. In self-driving mode, the vehicle 10 is driven primarily by the automatic control device 11. In self-driving mode, the automatic control device 11 controls operations such as steering, engine actuation and braking based on detection information from sensors (not shown) mounted in the vehicle 10. When operation in self-driving mode or manual driving mode is to begin, the automatic control device 11 outputs information indicating that operation in self-driving mode or manual driving mode is to begin, to the monitoring device 12. When operation in self-driving mode or manual driving mode is to end, the automatic control device 11 outputs information indicating that operation in self-driving mode or manual driving mode is to end, to the monitoring device 12.

In manual driving mode, the automatic control device 11 controls operation of the vehicle 10 including steering, actuation and braking based on manipulation by the driver 40. In manual driving mode, the vehicle 10 is driven primarily by the driver 40. In manual driving mode, the automatic control device 11 controls operation of the vehicle 10 based on operation of at least one from among the steering wheel 32, brake pedal 33 and accelerator pedal 34 by the driver 40.

Driving of the vehicle 10 primarily by the automatic control device 11 means that the automatic control device 11 controls the operations of steering, actuation and braking, without participation by the driver. Driving of the vehicle 10 primarily by the driver 40 means that the driver controls at least one of the operations from among steering, actuation and braking.

The automatic control device 11 may also have multiple self-driving levels in self-driving mode. As described herein, such multiple self-driving levels may include common self-driving levels of 3 to 5. Likewise, manual driving mode may include common self-driving levels of 0 to 2.

The automatic control device 11 detects objects such as other vehicles surrounding the vehicle 10 based on detection information from sensors (not shown) mounted in the vehicle 10. In self-driving mode, when a spacing of at least a predetermined distance cannot be maintained between the vehicle 10 and another object, the automatic control device 11 notifies the driver 40 of a control transfer request to switch main driving of the vehicle 10 from the automatic control device 11 to the driver 40, via the UI 6. In self-driving mode, the automatic control device 11 notifies the driver 40 of a control transfer request to switch driving from the automatic control device 11 to the driver 40, via the UI 6, before entering a region where driving by automatic control is not allowed. A region where driving by automatic control is not allowed may be a region where high-precision map information has not been provided. In self-driving mode, the automatic control device 11 also notifies the driver 40 of a control transfer request via the UI 6 when it has been determined that driving of the vehicle 10 cannot be safely controlled due to a sensor malfunction. The automatic control device 11 outputs the control transfer request to the monitoring device 12 via the in-vehicle network 14.

Once the driver 40 has been notified of the control transfer request, the automatic control device 11 carries out control transfer so that control of the vehicle 10 is transferred to the driver, at a predetermined control transfer time. If no acknowledgement action by the driver 40 for the control transfer request can be confirmed within the control transfer time, the automatic control device 11 safely stops the vehicle 10 (Minimal Risk Maneuver Processing).

When any one of the following three approval operations by the driver have been recognized, the automatic control device 11 switches from self-driving mode to manual driving mode. (1) gripping of the steering wheel 32 and operation of the accelerator pedal 34 by the driver 40, (2) gripping of the steering wheel 32 and operation of the brake pedal 33 by the driver 40, (3) gripping of the steering wheel 32 and operation of the steering wheel 32 by the driver 40.

When a control transfer request has been input from the automatic control device 11, the monitoring device 12 moves the driving seat 31 to the manual driving position.

The monitoring device 12 carries out control processing and determination processing. For this purpose, the monitoring device 12 has a communication interface (IF) 21, a memory 22 and a processor 23. The communication interface 21, memory 22 and processor 23 are connected via signal wires 24. The communication interface 21 has an interface circuit to connect the monitoring device 12 with the in-vehicle network 14.

The memory 22 is an example of a storage unit, and it has a volatile semiconductor memory and a non-volatile semiconductor memory, for example. The memory 22 stores an application computer program and various data to be used for information processing carried out by the processor 23.

All or some of the functions of the monitoring device 12 are functional modules driven by a computer program operating on the processor 23, for example. The processor 23 has a control unit 231 and a determining unit 232. Alternatively, the functional module of the processor 23 may be a specialized computing circuit in the processor 23. The processor 23 comprises one or more CPUs (Central Processing Units) and their peripheral circuits. The processor 23 may also have other computing circuits such as a logical operation unit, numerical calculation unit or graphics processing unit.

The control unit 231 moves the position of the driving seat 31 in response to operation of the seat operating unit 3 by the driver 40. In manual driving mode, the control unit 231 stores the position of the driving seat 31 set by the driver 40, as the “manual driving position”. The manual driving position may be set so as to include seat positions in a predetermined range. Operation of the monitoring device 12 will be described in detail below.

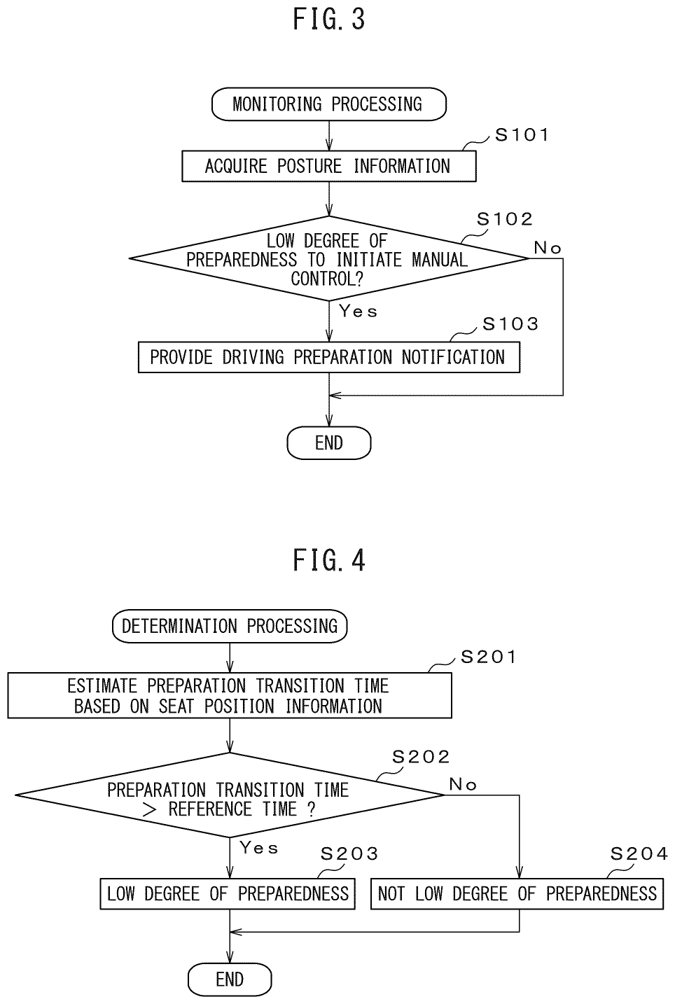

The automatic control device 11 and monitoring device 12 are electronic control units (Electronic Control Unit: ECU), for example. For FIG. 3, the automatic control device 11 and the monitoring device 12 were described as separate devices (for example, ECU), but all or some of the devices may also be constructed as a single device.

FIG. 3 is an example of an operation flow chart for monitoring processing by the monitoring device 12 of the embodiment. When the automatic control device 11 is in self-driving mode, the monitoring device 12 carries out monitoring processing according to the operation flow chart shown in FIG. 3, at a monitoring time having a predetermined cycle. The cycle for the monitoring time may be from 10 to 60 seconds, for example.

First, the control unit 231 acquires posture information representing the posture of the driver 40, acquired when the vehicle 10 is being driven by automatic control (step S101). The control unit 231 acquires seat position information as posture information, via the in-vehicle network 14. The control unit 231 also acquires a monitor image as posture information, via the in-vehicle network 14.

The determining unit 232 then determines whether or not the degree of preparedness of the driver 40 to initiate manual control is low, based on the posture information (step S102). Determination processing whereby the determining unit 232 determines whether or not the degree of preparedness of the driver 40 to initiate manual control is low will be described below.

When it has been determined that the degree of preparedness to initiate manual control is low (step S102—Yes), the control unit 231 provides a driving preparation notification via the UI 6 (step S103), and the series of processing steps is complete. The control unit 231 is an example of the notification control unit. By carrying out monitoring processing in a predetermined cycle, the driver 40 is given a driving preparation notification until the posture allowed for the driver 40 is reached, when the vehicle 10 is being driven by automatic control.

When it has been determined that the degree of preparedness to initiate manual control is low based on the seat position information, the control unit 231 may notify the driver 40 by display or voice via the UI 6 that the position of the driving seat 31 is to move forward.

When it has been determined that the degree of preparedness to initiate manual control is low based on a monitor image, the control unit 231 may notify the driver 40 by display or voice via the UI 6 so that more attention is directed toward operation of the vehicle 10.

The control unit 231 may also notify the driver 40 of the driving preparation notification by changing the temperature of the air conditioner, changing the strength of the air conditioner fan, changing the direction of the air conditioner fan, changing the intensity of illumination in the cabin 30, changing the color of illumination in the cabin 30 or vibrating the The control unit 231 continues to notify the driver 40 of the driving preparation notification until it no longer determines that the degree of preparedness to initiate manual control is low. The driver 40 can increase the degree of preparedness to initiate manual control by changing the position of the driving seat 31 or by improving posture to a state allowing operation.

The control unit 231 may also input from the automatic control device 11 a schedule to notify the driver 40 of a control transfer request. When the driver 40 has been scheduled to be notified of a control transfer request within 10 minutes, the control unit 231 may notify the driver 40 by greater emphasis of the driving preparation notification than usual. For example, the control unit 231 may notify the driver 40 of a driving preparation notification together with an alarm. When the air conditioner is used to provide a driving preparation notification, the control unit 231 may increase the strength of the fan above normal. When illumination in the cabin 30 is used to provide a driving preparation notification, the control unit 231 may increase the strength of illumination above normal.

When it has been determined that the degree of preparedness to initiate manual control is low (step S102—No), on the other hand, the series of processing steps is complete.

FIG. 4 is an example of an operation flow chart for determination processing by the monitoring device 12 of the embodiment. The determining unit 232 carries out determination processing based on the seat position information. The determining unit 232 carries out determination processing according to the operation flow chart shown in FIG. 4, at a first determining time with a predetermined cycle. The cycle for the first determining time may be 1 to 10 seconds, for example.

First, the determining unit 232 estimates the preparation transition time based on the seat position information (step S201). The preparation transition time is the time required to move the current position of the driving seat 31 to the manual driving position.

The determining unit 232 first estimates the moving time required to move the position of the seat cushion 31b in the front-back direction to the manual driving position, based on seat position information indicating the current position of the seat cushion 31b in the front-back direction.

Specifically, the determining unit 232 estimates the moving time required to move the position of the seat cushion 31b in the front-back direction to the manual driving position, based on the body weight (mass) of the driver 40, the mass of the driving seat 31, the driving force on the seat cushion 31b by the seat activating unit 4, the current seat position information and the manual driving position.

The body weight (mass) of the driver 40 may be input via the UI 5. The body weight (mass) of the driver 40 may also be a standard weight previously stored in the memory 22.

The determining unit 232 then similarly estimates the moving time required to move the position of the seat cushion 31b in the up-down direction to the manual driving position, based on seat position information indicating the current position of the seat cushion 31b in the up-down direction.

The determining unit 232 then similarly estimates the moving time required to move the inclination of the seat back 31a to the manual driving position, based on seat position information indicating the current inclination of the seat back 31a. The proportion of the body weight of the driver 40 added to the seat back 31a is also used when estimating the moving time for the seat back 31a.

The determining unit 232 then similarly estimates the moving time required to move the inclination of the headrest 31c and its position in the up-down direction to the manual driving position, based on inclination information indicating the current inclination of the headrest 31c and seat position information indicating its current position in the up-down direction. The proportion of the body weight of the driver 40 added to the headrest 31c is also used when estimating the moving time for the headrest 31c.

The determining unit 232 sets the maximum moving time among the moving times for moving the inclination or position of each part of the driving seat 31 to the manual driving position, as the current preparation transition time for the driving seat 31.

A longer preparation transition time for the driving seat 31 signifies that the seat cushion 31b is positioned further back, that the inclination of the seat back 31a is greater, or that the inclination indicating the inclination of the headrest 31c is greater.

If the seat cushion 31b is positioned further back, the inclination of the seat back 31a is greater or the inclination of the headrest 31c is greater, this means that the hands of the driver 40 are further from the steering wheel 32 or that the feet of the driver 40 are further from the brake pedal 33 and accelerator pedal 34.

If, however, the seat cushion 31b is positioned further back, the inclination of the seat back 31a is greater or the inclination of the headrest 31c is greater, it may be assumed that the driver 40 is in a more relaxed posture.

The determining unit 232 then determines whether or not the preparation transition time exceeds a predetermined reference time (step S202). The reference time is preferably decided based on the control transfer time required for the driver 40 to begin operation of the vehicle 10 in manual driving mode after the driver 40 has been notified of a control transfer request. Specifically, the reference time is calculated as the control transfer time minus the approval time required for the driver 40 to enact approval of the control transfer request. For example, if the control transfer time is 10 seconds and the approval time is 2 seconds, then the reference time is 8 seconds.

When the preparation transition time exceeds the reference time (step S202—Yes), the determining unit 232 determines that the degree of preparedness of the driver 40 to initiate manual control is low (step S203), and the series of processing steps is complete. When the driving seat 31 is at a location where the preparation transition time exceeds the reference time, this is an example where the degree of preparedness of the driver 40 to initiate manual control is the third degree, which is not allowed while the vehicle 10 is being operated by automatic control.

When the preparation transition time is zero or the preparation transition time does not exceed the reference time (step S202—No), on the other hand, the determining unit 232 determines that the degree of preparedness of the driver 40 to initiate manual control is not low (step S204), and the series of processing steps is complete. A preparation transition time of zero means that the driving seat 31 is in the manual driving position. When the driving seat 31 is in the manual driving position, this is an example of the degree of preparedness of the driver 40 to initiate manual control being the first degree in which manual control of the vehicle 10 is possible. When the driving seat 31 is at a location where the preparation transition time does not exceed the reference time, this is an example where the degree of preparedness of the driver 40 to initiate manual control is the second degree, which is allowed while the vehicle 10 is being operated by automatic control. In other words, the determining unit 232 determines that the degree of preparedness of the driver 40 to initiate manual control is the first degree, second degree or third degree.

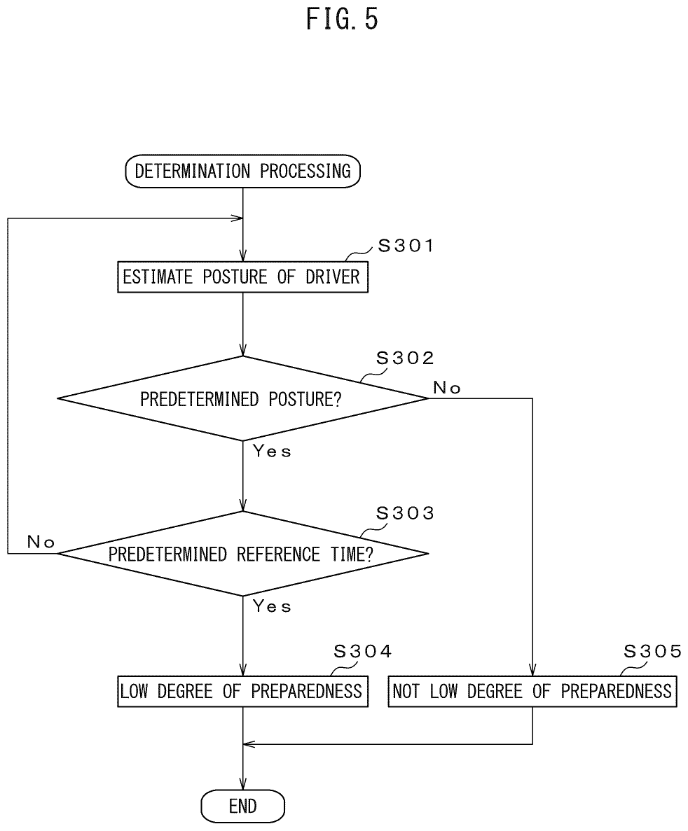

FIG. 5 is another example of an operation flow chart for determination processing by the monitoring device 12 of the embodiment. The determining unit 232 carries out determination processing based on monitor images, as posture information. The determining unit 232 carries out determination processing according to the operation flow chart shown in FIG. 5, at a second determining time with a predetermined cycle. The cycle for the second determining time may be 5 to 10 minutes, for example.

First, the determining unit 232 estimates the posture of the driver 40 based on a monitor image (step S301). The determining unit 232 estimates the posture of the driver 40 based on monitor images acquired by the monitoring cameras 2, 2a.

The determining unit 232 has an classifier trained so as to classifies the posture of the driver 40. The determining unit 232 inputs monitor images into the classifier to estimate the posture of the driver 40 represented in the monitor images. The classifier is preferably trained to classify a relaxed posture, such as a state of folded arms or crossed legs. The classifier also preferably classifies posture in which the driver 40 is operating a smartphone or laptop computer terminal.

The determining unit 232 then determines whether or not the driver 40 has adopted a predetermined posture (step S302). The predetermined posture may include a relaxed posture such as a folded arm posture or crossed leg posture. The predetermined posture also includes a posture in which the driver 40 is operating a smartphone or laptop computer terminal. Such postures of the driver 40 are examples where the degree of preparedness of the driver 40 to initiate manual control is the third degree, which is not allowed while the vehicle 10 is being operated by automatic control.

When the driver 40 is in a predetermined posture (step S302—Yes), the determining unit 232 determines whether or not a predetermined reference time has elapsed (step S303). The reference time may be 5 to 10 minutes, for example. If the driver 40 is in a predetermined posture during the reference time, it may be that the level of awareness of the driver 40 is not such as to recognize the notified control transfer request, judge the situation and immediately approve the control transfer request.

When the reference time has not elapsed (step S303—No), processing returns to before step S301. When the reference time has elapsed (step S303—Yes), on the other hand, the determining unit 232 determines that the degree of preparedness of the driver 40 to initiate manual control is low (step S304), and the series of processing steps is complete. This is because the level of awareness of the driver 40 for driving is reduced when the driver 40 has been in a predetermined posture for a long time.

When the driver 40 is not in a predetermined posture (step S302—No), the determining unit 232 determines that the degree of preparedness of the driver 40 to initiate manual control is not low (step S305), and the series of processing steps is complete. For example, when the driver 40 is in a posture without folded arms or a posture without crossed legs, the determining unit 232 determines that the degree of preparedness of the driver 40 to initiate manual control is not low (is high). Such postures of the driver 40 are examples where the degree of preparedness of the driver 40 to initiate manual control is the second degree, which is allowed while the vehicle 10 is being operated by automatic control.

When the driver 40 is in a posture operating the steering wheel 32 or the driver 40 is in a posture operating the brake pedal 33 or accelerator pedal 34, the determining unit 232 determines that the degree of preparedness of the driver 40 to initiate manual control is not low (is high). Such postures of the driver 40 are examples where the degree of preparedness of the driver 40 to initiate manual control is the first degree in which manual control of the vehicle 10 is possible. In other words, the determining unit 232 determines that the degree of preparedness of the driver 40 to initiate manual control is the first degree, second degree or third degree.

When the determining unit 232 has carried out the determination processing shown in FIG. 4 and the determination processing shown in FIG. 5 in step S102 and has determined in either processing that the degree of preparedness of the driver 40 to initiate manual control is low, the processing proceeds to step S103.

As explained above, the monitoring device of the embodiment can give the driver a notification to increase the degree of preparedness of the driver to initiate manual control when it has been determined that the degree of preparedness of the driver to initiate manual control is low. The driver can thus maintain a state that can return to a state allowing manual control within the predetermined time. The driver 10 can adopt a relaxed posture within a posture range allowed for the driver 40 when the vehicle 10 is being driven by automatic control.

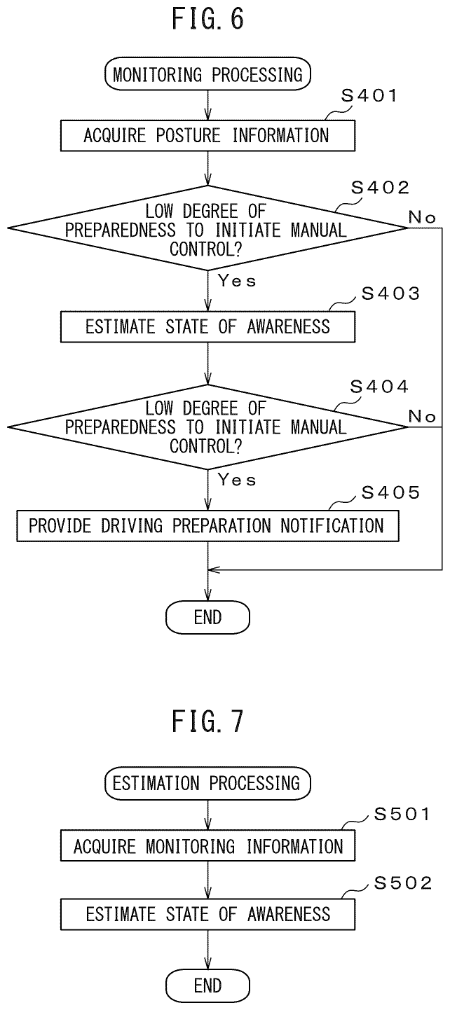

A modified example of the monitoring device of this embodiment will now be described with reference to FIG. 6, which is an example of an operation flow chart according to a modified example for monitoring processing by the monitoring device of the embodiment.

According to this modified example, when it has been determined that the degree of preparedness of the driver 40 to initiate manual control is low based on the posture information of the driver 40, and it has also been determined that the degree of preparedness of the driver 40 to initiate manual control is low based on the state of awareness indicating the degree to which the driver 40 is participating in driving, the driver 40 is given a driving preparation notification.

FIG. 6 shows processing with further addition of step S403 and step S404. In FIG. 6, step S401, step S402 and step S405 are the same as step S101 to step S103 described above.

When it has been determined that the degree of preparedness to initiate manual control is low based on the posture information (step S402—Yes), the determining unit 232 estimates the state of awareness of the driver 40 (step S403). Estimation processing for estimation of the state of awareness of the driver 40 is described below.

The determining unit 232 then determines whether or not the degree of preparedness of the driver 40 to initiate manual control is low, based on the state of awareness of the driver 40 (step S404). When it has been estimated that the state of awareness of the driver 40 is low, the determining unit 232 determines that the degree of preparedness of the driver 40 to initiate manual control is low.

For example, when the driver 40 feels drowsy and the degree of eye openness is low, it may be that the level of awareness of the driver 40 is not such as to recognize the notified control transfer request, judge the situation and immediately approve the control transfer request.

When it has not been estimated that the state of awareness of the driver 40 is low, on the other hand, the determining unit 232 does not determine that the degree of preparedness of the driver 40 to initiate manual control is low.

When the degree of preparedness of the driver 40 to initiate manual control is low (step S404—Yes), the control unit 231 provides a driving preparation notification for the driver 40 to increase the degree of preparedness to initiate manual control (step S405), and the series of processing steps is complete.

When the degree of preparedness of the driver 40 to initiate manual control is not low (step S404—No), on the other hand, the series of processing steps is complete.

Estimation processing by the monitoring device 12 will be described below with reference to FIG. 7, which is an example of an operation flow chart for estimation processing by the monitoring device 12 of the embodiment. The monitoring device 12 carries out estimation processing according to the operation flow chart shown in FIG. 7, at an estimation time having a predetermined cycle.

First, the determining unit 232 acquires monitoring information for the driver 40 (step S501). The monitoring information consists of monitor images acquired from the monitoring cameras 2, 2a.

The determining unit 232 then estimates the state of awareness of the driver 40 based on the monitoring information (step S502), and the series of processing steps is complete. Based on the monitor image, the determining unit 232 determines participation information representing the degree to which the driver 40 is participating in driving. The participation information includes the degree of eye openness, degree of mouth openness, line of sight orientation, frequency of viewing the rearview mirror (not shown) or frequency of blinking by the driver 40. Incidentally, the determining unit 232 may determine the degree of eye openness, the degree of mouth openness, the line of sight orientation, the frequency of viewing the rearview mirror (not shown) or the frequency of blinking by the driver 40.

The degree of eye openness, the degree of mouth openness, the line of sight orientation, the frequency of viewing the rearview mirror (not shown) and the frequency of blinking by the driver 40 are examples of participation information representing the degree to which the driver 40 is participating in driving. Increased drowsiness of the driver 40, for example, will alter these items of participation information. Based on the participation information, the determining unit 232 estimates the state of awareness representing the degree to which the driver is participating in driving.

The determining unit 232 estimates that the state of awareness of the driver 40 is low when a state in which the degree of eye openness of the driver 40 is lower than a predetermined reference degree of eye openness continues for a predetermined time. The predetermined time may be 5 to 10 minutes, for example.

The determining unit 232 also estimates that the state of awareness of the driver 40 is low when a state in which the degree of mouth openness of the driver 40 is higher than a predetermined reference degree of mouth openness continues for a predetermined time. The predetermined time may be 5 to 10 minutes, for example.

The determining unit 232 also estimates that the state of awareness of the driver 40 is low when a state in which the line of sight orientation of the driver 40 is outside of a predetermined range continues for a predetermined time. The predetermined range may be 30° left and right and 30° up and down with respect to the traveling direction of the vehicle 10, for example. The predetermined time may be 5 to 10 minutes, for example.

The determining unit 232 estimates that the state of awareness of the driver 40 is low when a state in which the frequency of viewing the rearview mirror (not shown) in the cabin 30 is below a predetermined reference frequency continues for a predetermined time. The predetermined reference frequency may be 3 times per minute, for example. The predetermined time may be 5 to 10 minutes, for example.

The determining unit 232 estimates that the state of awareness of the driver 40 is low when a state in which the frequency of blinking is below a predetermined reference frequency continues for a predetermined time. The predetermined reference frequency may be 10 times per minute, for example. The predetermined time may be 5 to 10 minutes, for example.

In the modified example described above, the monitoring device 12 can accurately determine the degree of preparedness of the driver to initiate manual control, based on posture information as well as the state of awareness.

The monitoring device, computer program for monitoring and monitoring method according to the embodiments described in the present disclosure may incorporate appropriate modifications that still fall within the gist of the disclosure. Moreover, the technical scope of the disclosure is not limited to these embodiments, and includes the invention and its equivalents as laid out in the claims.

For example, in the embodiment described above the posture information was acquired based on the position of the driving seat and monitor images, but the posture information may also be acquired by other methods. Moreover, the examples of driving preparation notification explained for the embodiment are merely examples and are not intended to place restrictions on the driving preparation notification.

1. A monitoring device comprising:
a processor configured to
determine whether a degree of preparedness of a driver to initiate manual control is a first degree in which manual control of a vehicle is possible, a second degree which is allowed while the vehicle is being operated by automatic control or a third degree which is not allowed while the vehicle is being operated by automatic control, based on posture information indicating a posture of the driver, acquired while the vehicle is being operated by automatic control, and
provide a predetermined notification to increase the degree of preparedness of the driver to initiate manual control, via a notification unit, when it has been determined that the degree of preparedness to initiate manual control is the third degree.

2. The monitoring device according to claim 1, wherein the processor is further configured to
estimate a transfer time required for the driver to be in a state allowing initiation of operation of the vehicle in manual driving mode, after the driver has been notified via the notification unit of a transfer request for transfer from self-driving mode in which the vehicle is driven by automatic control to manual driving mode in which the vehicle is driven by manual control, based on the posture information, and
determine that the degree of preparedness of the driver to initiate manual control is the first degree when the transfer time is zero, determine that the degree of preparedness of the driver to initiate manual control is the second degree when it has been determined that the transfer time does not exceed a predetermined reference time, and determine that the degree of preparedness of the driver to initiate manual control is the third degree when it has been determined that the transfer time exceeds the predetermined reference time.

3. The monitoring device according to claim 2, wherein the predetermined reference time is decided based on time required for the driver to begin operation of the vehicle in manual driving mode after the driver has been notified of the control transfer request.

4. The monitoring device according to claim 2, wherein
the posture information includes seat position information indicating a position of the driving seat in which the driver is seated, and
the processor is further configured to estimate the transfer time based on the seat position information.

5. The monitoring device according to claim 1, wherein
the posture information includes an image in which the driver is represented, and
the processor is further configured to determine that the degree of preparedness to initiate manual control is the third degree when the driver represented in the image is in a predetermined posture.

6. The monitoring device according to claim 5, wherein the predetermined posture includes an arm-folded posture and a leg-crossed posture.

7. The monitoring device according to claim 1, wherein the processor is further configured to determine whether or not the degree of preparedness of the driver to initiate manual control is low based on the state of awareness indicating a degree to which the driver is participating in driving, and
provide the predetermined notification to the driver when it has been determined based on the posture information that the degree of preparedness of the driver to initiate manual control is the third degree, and it has been determined based on the state of awareness that the degree of preparedness of the driver to initiate manual control is low.

8. A non-transitory storage medium storing a computer-readable computer program for monitoring which causes a processor to execute a process, the process comprising:
determining whether a degree of preparedness of a driver to initiate manual control is a first degree in which manual control of a vehicle is possible, a second degree which is allowed while the vehicle is being operated by automatic control or a third degree which is not allowed while the vehicle is being operated by automatic control, based on posture information indicating a posture of the driver, acquired while the vehicle is being operated by automatic control; and
providing a predetermined notification to increase the degree of preparedness of the driver to initiate manual control, via a notification unit, when it has been determined that the degree of preparedness to initiate manual control is the third degree.

9. A monitoring method carried out by a monitoring device, the method comprising:
determining whether a degree of preparedness of a driver to initiate manual control is a first degree in which manual control of a vehicle is possible, a second degree which is allowed while the vehicle is being operated by automatic control or a third degree which is not allowed while the vehicle is being operated by automatic control, based on posture information indicating a posture of the driver, acquired while the vehicle is being operated by automatic control; and
providing a predetermined notification to increase the degree of preparedness of the driver to initiate manual control, via a notification unit, when it has been determined that the degree of preparedness to initiate manual control is the third degree.
